(19) United States
(12) Patent Application Publication
(10) Pub. No.: US 2026/0367441 A1
(43) Pub. Date: Nov. 19, 2026

(54) NARROW FIELD OF VIEW ANGULAR LIGHT CONTROL FILM

(71) Applicant: 3M INNOVATIVE PROPERTIES COMPANY, St. Paul, MN (US)

(72) Inventors: Justin M. Foley, Minneapolis, MN (US); David J. Rowe, Roseville, MN (US); Tri D. Pham, Woodbury, MN (US); William F. Edmonds, Edina, MN (US); William J. Gray, Woodbury, MN (US); Kevin D. Hagen, St. Paul, MN (US); Nicholas A. Johnson, Burnsville, MN (US); William B. Kolb, Stillwater, MN (US)

(21) Appl. No.: 19/487,044

(22) PCT Filed: May 21, 2024
(86) PCT No.: PCT/IB2024/054931

§ 371 Date: Nov. 24, 2025

Related U.S. Application Data
(60) Provisional application No. 63/469,968, filed on May 31, 2023.

(51) Int. Cl. G02F 1/1335

(52) U.S. Cl. CPC G02F 1/133512; G02F 1/133504; G02F 1/133526; G02F 1/133536; G02F 1/133553; G02F 1/133567

(57) ABSTRACT

An optical assembly including an extended illumination source configured to emit light from an extended emission surface thereof, and a light control film disposed on, and substantially co-extensive in length and width with, the extended illumination source. The light control film includes a plurality of optically transparent first beads at least partially embedded in a first layer, and a light rejecting second layer disposed between, and substantially parallel to, the first layer and the emission surface. The light rejecting second layer defines a plurality of through openings therein extending between opposite major top and bottom surfaces of the light rejecting second light absorbing layer. The through openings are aligned to the first beads in a one-to-one correspondence.

### SUMMARY

In some aspects of the present description, an optical assembly is provided, the optical assembly including an extended illumination source configured to emit light from an extended emission surface thereof, and a light control film disposed on, and substantially co-extensive in length and width with, the extended illumination source. The light control film includes a plurality of optically transparent first beads at least partially embedded in a first layer, and a light rejecting second layer disposed between, and substantially parallel to, the first layer and the emission surface. The light rejecting second layer defines a plurality of through openings therein extending between opposite major top and bottom surfaces of the light rejecting second light absorbing layer. The through openings are aligned to the first beads in a one-to-one correspondence.

In some aspects of the present description, a display system is provided, the display system including a backlight configured to emit light from an extended emission surface thereof, a liquid crystal display panel disposed on the backlight and configured to receive the emitted light and form an image for viewing by a viewer, and a light control film disposed between the display panel and the backlight. The light control film includes a light rejecting layer defining a plurality of through openings therein for transmitting the emitted light therethrough toward the display panel. When the backlight is replaced with a substantially Lambertian light source that is substantially co-extensive in length and width with the extended emission surface and emits a Lambertian light that has a substantially Lambertian intensity distribution across the extended emission surface, then the emitted Lambertian light exits the display system having a peak intensity Ip at a first exit angle and a peak intensity of about Ip/2 at a second exit angle. A magnitude of a difference between the first and second exit angles is less than about 20 degrees.

In some aspects of the present description, a display system is provided, the display system including a display panel configured to form an image on a viewing side thereof for viewing by a viewer, a light rejecting layer, and a plurality of substantially spherical optically transparent beads. The light rejecting layer is disposed on a non-viewing side, opposite the viewing side, of, and substantially co-extensive in length and width with, the display panel. The light rejecting layer further defines a plurality of openings therein. The plurality of substantially spherical optically transparent beads is disposed between the display panel and the light rejecting layer and are arranged so at to be substantially aligned with the openings in one-to-one correspondence. When the light rejecting layer side of the display system is illuminated with a substantially Lambertian light source that emits a Lambertian light that has a substantially Lambertian intensity distribution across the light rejecting layer, the emitted Lambertian light exits the beads after passing through the openings. The exiting light has an intensity profile having a peak along a peak direction making a peak angle with a normal to the light rejecting layer and a corresponding largest full width at half maximum (FWHM) in a first plane that includes the peak direction and a second FWHM in a second plane that includes the peak direction and is orthogonal to the first plane. A ratio of the largest FWHM to the second FWHM is at least 1.1.

### BRIEF DESCRIPTION OF THE DRAWINGS

FIG. 1 is a schematic, side view of a display system having an angular light control film, in accordance with an embodiment of the present description;

FIGS. 2A and 2B show side, cross-sectional views of a layer of optically transparent beads from an angular light control film, in accordance with an embodiment of the present description;

FIG. 3 is a schematic, side view of an angular light control film, in accordance with an embodiment of the present description;

FIGS. 4A-4B provide views of a display system having an angular light control film and a Lambertian light source, in accordance with an embodiment of the present description;

FIG. 5 is a schematic, side view of a multilayer optical film, in accordance with an embodiment of the present description;

FIGS. 6A-6B provide plots showing the optical characteristics of an angular light control film, in accordance with an embodiment of the present description; and

FIGS. 7A-7B are charts providing data for use in the Examples section of this specification.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

For some display applications, a narrow field of view (FOV) is desired. Conventional displays have a large FOV (±60°). To reduce the field of view for certain applications, various louver films have been developed for both 1D and 2D FOV engineering. For moderate reduction in FOV (±30°-45°) skived louvers have been used for decades. For very narrow FOV (±10°) there are challenging manufacturing constraints that result in very expensive skived louver products. To reduce cost and improve capability, a new narrow FOV solution must be found.

One example application for narrow FOV displays is passenger displays used in automotive applications. These displays should not be visible to the driver for safety reasons. To make a display visible to a passenger but not to the driver, horizontal light control must be strictly managed. Existing solutions to produce narrow FOV displays are often prohibitively expensive and lacking in performance and quality. Also, existing narrow FOV solutions can introduce vignetting (i.e., dimming) near the edges of a display. There is a need for a narrow FOV solution that can be used to direct light in different directions across the display to provide very narrow FOV while also ensuring uniform intensity directed to the viewer.

According to some aspects of the present description, a light control film including a self-assembled array of polymer beads is used to act as a lens array. These beads may be embedded in a black binder such that the bottom of the beads is not occluded and optical crosstalk between the beads is minimized. In some embodiments, the bead array may be disposed above a spacer layer that is designed with a thickness equal to the focal length of the bead lenses. In some such embodiments, a metal layer may be disposed below the spacer layer which acts as an aperture layer to define the angles of the outgoing light.

According to some aspects of the present description, an optical assembly includes an extended illumination source configured to emit light from an extended emission surface thereof, a light control film disposed on the extended illumination source, and a light rejecting second layer disposed between, and substantially parallel to, the first layer and the emission surface. In some embodiments, the light control film is substantially co-extensive in length (e.g., along an x-axis of the film) and width (e.g., along a y-axis of the film) with the extended illumination source. In some embodiments, the light control film may include a plurality of optically transparent first beads at least partially embedded in a first layer, and a light rejecting second layer disposed between, and substantially parallel to, the first layer and the emission surface. In some embodiments, the light rejecting second layer may define a plurality of through openings therein extending between opposite major top and bottom surfaces of the light rejecting second light absorbing layer. In some such embodiments, the through openings may be aligned to the first beads in a one-to-one correspondence.

For the purposes of this specification, a “through opening” shall be defined as a substantially optically transmissive region. This may include, but is not limited to, a through-hole or chemical composition change to make a material optically transmissive. In some embodiments, “optically transmissive” may be defined as transmitting about 50% or greater of incident light.

In some embodiments, the first beads may have an average size in a range from about 2 microns, or about 3 microns, or about 4 microns, or about 5 microns, or about 7 microns, or about 10 microns, or about 15 microns to about 50 microns, or about 45 microns, or about 40 microns, or about 35 microns, or about 30 microns, or about 25 microns, or about 20 microns. In some embodiments, for at least one visible wavelength in a visible wavelength range extending from about 420 nm to about 680 nm, the first beads may have an index of refraction in a range from about 1.41, or about 1.42, or about 1.43, or about 1.45, or about 1.47, or about 1.49, or about 1.5, or about 1.52 to about 1.6 (or about 1.7, or about 1.8, or about 2, or about 2.2, or about 2.3, or about 2.4, or about 2.5. In some embodiments, at least some of the first beads may include one or more of polymeric beads, glass beads, silicone beads, ceramic beads, and plastic beads. In some embodiments, the first beads may be substantially spherical beads.

In some embodiments, the first beads may be completely embedded in the first layer. In some such embodiments, at least some of the completely embedded first beads may define corresponding protrusions on a major top surface of the first layer (i.e., protrusions formed where a bead pushes up from a plane defined by the major top surface but is still completely embedded in the material of the first layer).

In some embodiments, the optical assembly may further include a spacer layer disposed between the first layer and the light rejecting second layer. In some such embodiments, a thickness (e.g., in a z-direction of the film) of the spacer layer may be such that, when a substantially collimated light is substantially normally incident on the optical assembly, each of the first beads focuses the incident light to a focal spot disposed within, or adjacent to, the through opening corresponding to the first bead.

In some embodiments, the optical assembly may further include a substrate layer disposed on the light rejecting second layer opposite the first layer. In some such embodiments, the substrate layer may include a plurality of polymeric layers numbering at least 10, or at least 20, or at least 50, or at least 100, or at least 200, or at least 300, or at least 400 in total. In some such embodiments, an average thickness of each of the polymeric layers may be less than about 500 nm, or less than about 450 nm, or less than about 400 nm, or less than about 350 nm, or less than about 300 nm, or less than about 250 nm, or less than about 200 nm. In some such embodiments, the substrate layer further includes at least one skin layer having an average thickness of greater than about 500 nm, or greater than about 750 nm, or greater than about 1000 nm, or greater than about 1250 nm, or greater than about 1500 nm. In some such embodiments, for a substantially normally incident light and a visible (i.e., human-visible) wavelength range extending from about 420 nm to about 680 nm, the plurality of polymeric layers may have an average reflectance of greater than about 50%, or greater than about 60%, or greater than about 70%, or greater than about 80%, or greater than about 90%, or greater than about 95% when the incident light is polarized along a first in-plane direction (e.g., along an x-axis of the film) and an average transmittance of greater than about 60%, or greater than about 70%, or greater than about 80%, or greater than about 90%, or greater than about 95% when the incident light is polarized along an orthogonal second in-plane direction (e.g., along a y-axis of the film). In some embodiments, a bonding layer may bond the light rejecting second layer to the substrate layer.

In some embodiments, the light rejecting second layer may reject light primarily by absorbing the light. In some such embodiments, the optically absorbing light rejecting second layer may have an average optical density of greater than about 1, or greater than about 2, or greater than about 2.5, or greater than about 3 in a visible wavelength range extending from about 420 nm to about 680 nm. In some such embodiments, the optically absorbing light rejecting second layer may include one or more of a light absorbing pigment, a light absorbing dye and carbon black. In some embodiments, the optically absorbing light rejecting second layer may have a black or a dark gray color.

In some embodiments, the light rejecting second layer may reject light primarily by reflecting the light. In some such embodiments, the optically reflective light rejecting second layer may have an average optical reflectance of greater than about 50%, or greater than about 55%, or greater than about 60%, or greater than about 65%, or greater than about 70%, or greater than about 75%, or greater than about 80%, or greater than about 85%, or greater than about 90%, or greater than about 95% in a visible wavelength range extending from about 420 nm to about 680 nm. In some such embodiments, the optically reflective light rejecting second layer may include a metal. In some such embodiments, the metal may include one or more of silver, copper, gold, aluminum and tungsten.

In some embodiments, the first layer may be optically transparent and have an average optical transmittance of greater than about 80%, or greater than about 85%, or greater than about 90%, or greater than about 95% in a visible wavelength range extending from about 420 nm to about 680 nm. In some embodiments, the first layer may be optically light absorbing and have an average optical density of greater than about 0.01, or greater than about 0.03, or greater than about 0.05, or greater than about 0.1 in a visible wavelength range extending from about 420 nm to about 680 nm.

In some embodiments, the extended illumination source may include a lightguide for propagating light therein along a length (e.g., along an x-axis) and width (e.g., along a y-axis) of the lightguide, and at least one light source. In some such embodiments, the lightguide may be disposed between a back reflector and the extended emission surface. In some embodiments, the at least one light source may be disposed proximate an edge surface of the lightguide. In some such embodiments, the back reflector may be configured to reflect light that exits the lightguide toward the back reflector.

In some embodiments, the extended illumination source may include a reflective layer, an optically diffusive layer, and at least one light source. In some embodiments, the optically diffusive layer may be disposed on the reflective layer and may include the extended emission surface, or may be disposed proximate the extended emission surface. In some embodiments, the optically diffusive layer and the reflective layer may be substantially coextensive with each other in length (e.g., along an x-axis) and width (e.g., along a y-axis) and may define an optical cavity therebetween. In some embodiments, the at least one light source may be disposed in or proximate the optical cavity.

In some embodiments, the extended illumination source may include a reflective polarizer. In some such embodiments, for a substantially normally incident light and a visible wavelength range extending from about 420 nm to about 680 nm, the reflective polarizer may have an average reflectance of greater than about 60%, or greater than about 70%, or greater than about 80%, or greater than about 90%, or greater than about 95% when the incident light is polarized along a first in-plane direction (e.g., along an x-axis) and an average transmittance of greater than about 60%, or greater than about 70%, or greater than about 80%, or greater than about 90%, or greater than about 95% when the incident light is polarized along an orthogonal second in-plane direction (e.g., along a y-axis).

In some embodiments, the extended illumination source may further include a first prismatic film having a plurality of first prisms extending along a first longitudinal direction (e.g., along a y-axis). In some such embodiments, the extended illumination source may further include a second prismatic film disposed proximate the first prismatic film and having a plurality of second prisms extending along a second longitudinal direction (e.g., an x-axis) different from the first longitudinal direction.

In some embodiments, the optical assembly may be part of a display system. In some embodiments, the display system may include a display panel disposed on the optical assembly such that the light control film is disposed between the display panel and the extended illumination source with the first beads facing the display panel. In some embodiments, the display panel may be configured to receive the light emitted from the extended emission surface and form an image for viewing by a viewer. In some such embodiments, the display panel may include a liquid crystal display panel.

In some embodiments, the display system may include the optical assembly, and the extended illumination source may include a display having a plurality of pixels. In some embodiments, the display may be configured to form and emit an image. In some embodiments, the emitted image may be transmitted through the extended emission surface and the light control film for viewing by a viewer. In some such embodiments, the display may be or include a liquid crystal display (LCD).

In some embodiments, the display may include an emissive display having a plurality of light emitting pixels. In some such embodiments, the light emitting pixels may include one or more of inorganic light emitting diodes and organic light emitting diodes.

According to some aspects of the present description, a display system includes a backlight configured to emit light from an extended emission surface thereof, a liquid crystal display panel disposed on the backlight and configured to receive the emitted light and form an image for viewing by a viewer, and a light control film disposed between the display panel and the backlight. In some embodiments, the light control film includes a light rejecting layer defining a plurality of through openings therein for transmitting the emitted light therethrough toward the display panel. In some embodiments, when the backlight is replaced with a substantially Lambertian light source that is substantially co-extensive in length (e.g., an x-axis) and width (e.g., a y-axis) with the extended emission surface and emits a Lambertian light that has a substantially Lambertian intensity distribution across the extended emission surface, then the emitted Lambertian light exits the display system having a peak intensity Ip at a first exit angle and a peak intensity of about Ip/2 at a second exit angle.

In some embodiments, a magnitude of a difference between the first and second exit angles may be less than about 20 degrees, or less than about 15 degrees, or less than about 10 degrees, or less than about 5 degrees. In some embodiments, the first exit angle may be less than about 10 degrees, or less than about 8 degrees, or less than about 6 degrees, or less than about 4 degrees, or less than about 2 degrees, or less than about 1 degree. In some embodiments, the first exit angle may be greater than about 5 degrees, or greater than about 10 degrees, or greater than about 15 degrees, or greater than about 20 degrees. In some embodiments, the second exit angle is greater than about 10 degrees, or greater than about 12.5 degrees, or greater than about 15 degrees, or greater than about 17.5 degrees, or greater than about 20 degrees, or greater than about 25 degrees, or greater than about 30 degrees.

In some embodiments of the display system, the backlight may include an edge-lit backlight having at least one light source disposed proximate an edge surface in the backlight. In some embodiments, the backlight may include a direct-lit backlight having at least one light source disposed below, and away from a periphery of, the extended emission surface opposite the light control film.

According to some aspects of the present description, a display system includes a display panel configured to form an image on a viewing side thereof for viewing by a viewer, a light rejecting layer, and a plurality of substantially spherical optically transparent beads disposed between the display panel and the light rejecting layer. In some embodiments, the light rejecting layer may be disposed on a non-viewing side, opposite the viewing side, of, and substantially co-extensive in length (e.g., an x-axis) and width (e.g., a y-axis) with, the display panel and may define a plurality of openings therein.

In some embodiments, the plurality of substantially spherical optically transparent beads may be arranged so as to be substantially aligned with the openings in one-to-one correspondence. In some embodiments, when the light rejecting layer side of the display system is illuminated with a substantially Lambertian light source that emits a Lambertian light that has a substantially Lambertian intensity distribution across the light rejecting layer, then the emitted Lambertian light exits the beads after passing through the openings. In some embodiments, the exiting light may have an intensity profile having a peak along a peak direction (e.g., a thickness direction or the z-axis) making a peak angle with a normal to the light rejecting layer and a corresponding largest full width at half maximum (FWHM) in a first plane (e.g., the yz-plane of the display surface) that includes the peak direction and a second FWHM in a second plane (e.g., in the xz-plane of the display surface) that includes the peak direction and is orthogonal to the first plane. In some embodiments, a ratio of the largest FWHM to the second FWHM is at least 1.1, or at least 1.2, or at least 1.3, or at least 1.4, or at least 1.5, or at least 2, or at least 2.5, or at least 3.

In some embodiments, the peak angle may be less than about 10 degrees, or less than about 8 degrees, or less than about 6 degrees, or less than about 4 degrees, or less than about 2 degrees. In some embodiments, the largest FWHM may be less than about 60 degrees, or less than about 50 degrees, or less than about 40 degrees, or less than about 30 degrees, or less than about 20 degrees. In some embodiments, the second FWHM is less than about 30 degrees, or less than about 25 degrees, or less than about 20 degrees, or less than about 15 degrees, or less than about 10 degrees.

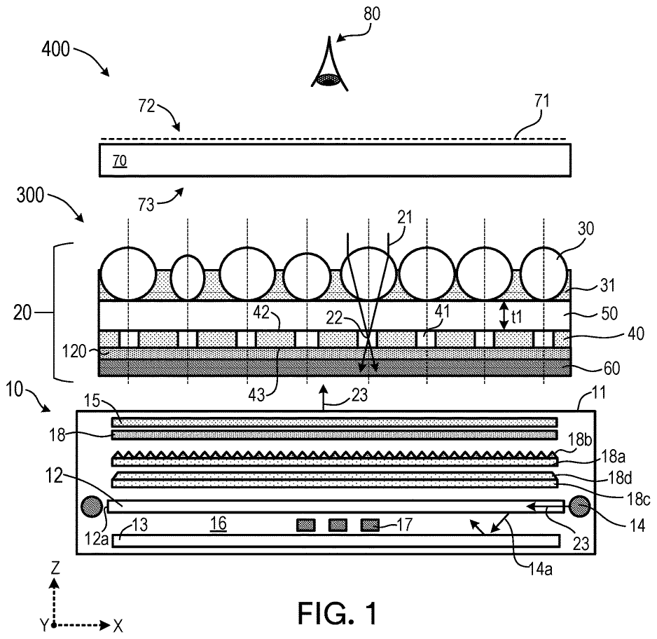

Turning now to the figures, FIG. 1 is a schematic, side view of one embodiment of a display system having an angular light control film, according to the present description. In some embodiments, display system 400 includes a display panel 70 configured to form an image 71 for viewing by a viewer 80 on a viewer side 72 of the display panel, disposed on an optical assembly 300.

In some embodiments, optical assembly 300 includes an extended illumination source 10, a light control film 20, and a light rejecting layer 40. In some embodiments, extended illumination source 10 may be configured to emit light 23 from an extended emission surface 11. In some embodiments, light control film 20 may be disposed on, and substantially co-extensive in length (e.g., along the x-axis of FIG. 1) and width (e.g., along the y-axis) with, extended illumination source 10 (on a non-viewing side 73 of display panel 70).

In some embodiments, light control film 20 may include a plurality of optically transparent first beads 30 at least partially embedded in a first layer 31. In some embodiments, light rejecting second layer 40 may be disposed between, and substantially parallel to, first layer 31 and emission surface 11. In some embodiments, light rejecting second layer 40 may define a plurality of through openings 41 therein extending between major top surface 42 and opposite bottom surface 43 of light rejecting second layer 40. In some embodiments, through openings 41 may be aligned to first beads 30 in a one-to-one correspondence.

In some embodiments, a spacer layer 50 may be disposed between first layer 31 and light rejecting second layer 40. For example, a spacer layer 50 may be used to adjust a focal length relative to the location of the through openings 41. In some embodiments, a thickness t1 of spacer layer 50 may be such that when a substantially collimated light 21 is substantially normally incident on optical assembly 300, then each of first beads 30 focuses the incident light 21 to a focal spot 22 disposed within, or adjacent to, the through opening 41 corresponding to the first bead 30.

In some embodiments, the optical assembly may further include a substrate layer 60 disposed on light rejecting second layer 40 opposite first layer 31. In some such embodiments, a bonding layer 120 may bond light rejecting second layer 40 to substrate layer 60.

In some embodiments, the extended illumination source 10 may further include a lightguide 12 for propagating light 23 therein along a length (e.g., along the x-axis as shown in FIG. 1) and width (e.g., along the y-axis) of lightguide 12. In some embodiments, lightguide 12 may be disposed between a back reflector 13 and extended emission surface 11. In some embodiments, the extended illumination source 10 may further include at least one light source 14 disposed proximate an edge surface 12a of lightguide 12. In some such embodiments, back reflector 13 may be configured to reflect light 14a that exits lightguide 12 toward back reflector 13.

In some other embodiments, the extended illumination source may include a reflective layer (such as back reflector 13), an optically diffusive layer 15 (e.g., an optical diffuser) disposed on reflective layer 13, and at least one light source 17. In some embodiments, the optically diffusive layer 15 may include, or be disposed proximate, extended emission surface 11, such that optically diffusive layer 15 and reflective layer 13 are substantially coextensive with each other in length (e.g., x-axis) and width (e.g., y-axis) and define an optical cavity 16 therebetween. In some embodiments, the at least one light source 17 may be disposed in or proximate (see, e.g., example embodiment light source 14) optical cavity 16.

In some embodiments, the extended illumination source may further include a reflective polarizer 18. In some such embodiments, for a substantially normally incident light and a visible wavelength range extending from about 420 nm to about 680 nm, reflective polarizer 18 may have an average reflectance of greater than about 60%, or greater than about 70%, or greater than about 80%, or greater than about 90%, or greater than about 95% when the incident light is polarized along a first in-plane direction (e.g., along the x-axis of FIG. 1) and an average transmittance of greater than about 60%, or greater than about 70%, or greater than about 80%, or greater than about 90%, or greater than about 95% when the incident light is polarized along an orthogonal second in-plane direction (e.g., the y-axis).

In some embodiments, the extended illumination source may further include a first prismatic film 18a having a plurality of first prisms 18b extending along a first longitudinal direction (e.g., the y-axis). In some such embodiments, the extended illumination source may further include a second prismatic film 18c disposed proximate first prismatic film 18a and having a plurality of second prisms 18d extending along a second longitudinal direction (e.g., x-axis) different from the first longitudinal direction.

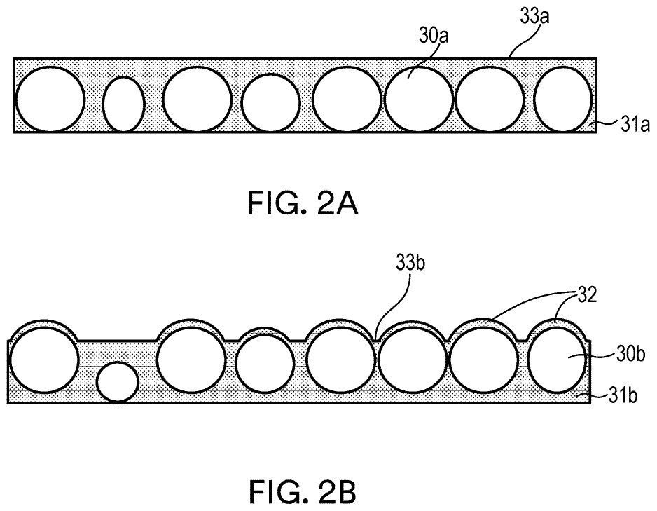

FIGS. 2A and 2B show side, cross-sectional views of different embodiments of a layer of optically transparent beads from an angular light control film, according to the present description. The embodiments shown in FIGS. 2A and 2B may be variation the plurality of optically transparent first beads 30 at least partially embedded in a first layer 31 of light control film 20, as shown in FIG. 1. For example, in the embodiment shown in FIG. 2A, first beads 30a are completely embedded in the first layer 31a (i.e., that is, most or all of beads 30a are fully contained within first layer 31a, such that a major top surface 33a of first layer 31a is substantially planar and substantially lacks “protrusions” that extend above planar top surface 33a. In other embodiments, such as the embodiment of FIG. 2B, at least some of the completely embedded first beads 30b define corresponding protrusions 32 on a major top surface 33b of first layer 31b. In such embodiments, first beads 30b remain completely embedded in first layer 31b (i.e., the material of the first layer 31b substantially covers all of first beads 30b).

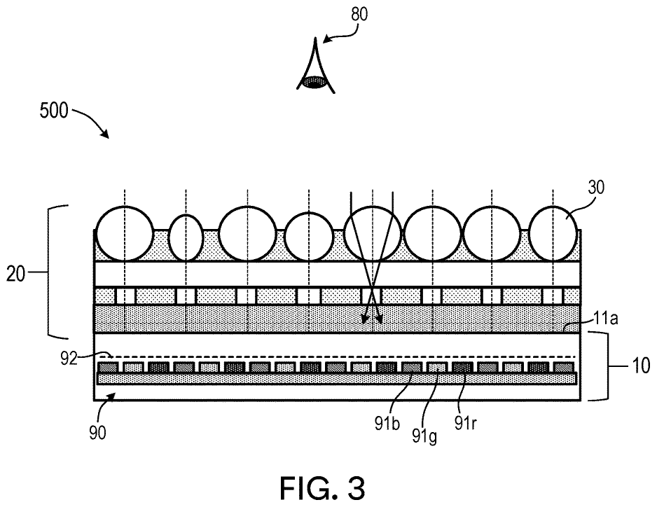

FIG. 3 is a schematic, side view of another embodiment of a display system having an angular light control film, according to the present description. In some embodiments, display system 500 may include any of the embodiments of an optical assembly described herein. In some embodiments, the extended illumination source 10 may include a display 90 having a plurality of pixels 91b, 91g, 91r. In some embodiments, the display is configured to form and emit an image 92, wherein the emitted image 92 is transmitted through the extended emission surface 11a and the light control film 20 for viewing by a viewer 80.

In some embodiments, display 90 may include a liquid crystal display (LCD). In some embodiments, display 90 may include an emissive display (e.g., an LED or OLED display) comprising a plurality of light emitting pixels 91b, 91g, 91r. In some such embodiments, the light emitting pixels may include one or more of inorganic light emitting diodes and organic light emitting diodes.

In some embodiments, the first beads may have an average size in a range from about 2 microns, or about microns 3, or about microns 4, or about microns 5, or about microns 7, or about microns 10, or about microns, or about 15 microns to about 50 microns, or about 45 microns, or about 40 microns, or about 35 microns, or about 30 microns, or about 25 microns, or about 20 microns.

In some embodiments, for at least one visible wavelength in a visible wavelength range extending from about 420 nm to about 680 nm, the first beads 30 have an index of refraction in a range from about 1.41, or about 1.42, or about 1.43, or about 1.45, or about 1.47, or about 1.49, or about 1.5, or about 1.52 to about 1.6 (or about 1.7, or about 1.8, or about 2, or about 2.2, or about 2.3, or about 2.4, or about 2.5. In some embodiments, at least some of the first beads 30 comprise one or more of polymeric beads, glass beads, silicone beads, ceramic beads, and plastic beads. In some embodiments, the first beads 30 may be substantially spherical beads.

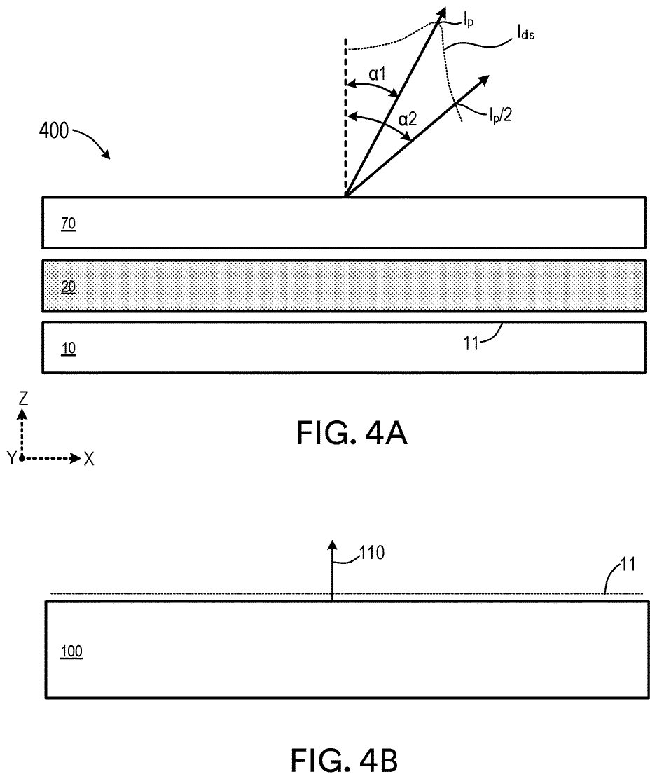

FIG. 4A shows a simplified version of a display system 400, such as the embodiment of display system 400 of FIG. 1. FIG. 4B provide a simplified view of a Lambertian light source, according to the present description. Looking at FIG. 4A, display system 400 includes a display 70, a backlight 10, and a light control film 20 disposed between the display 70 and backlight 10. As described elsewhere herein, light control film 20 may include a light rejecting layer (e.g., see element 40, FIG. 1) defining a plurality of through openings 41 therein for transmitting the emitted light therethrough toward display panel 70, such that, when the backlight is replaced with a substantially Lambertian light source 100 (see FIG. 4B) that is substantially co-extensive in length (e.g., the x-axis of FIG. 4A) and width (e.g., the y-axis) with the extended emission surface 11 and emits a Lambertian light 110 that has a substantially Lambertian intensity distribution (e.g., see dotted example distribution line, I_{dis}, superimposed on FIG. 4A) across the extended emission surface, then the emitted Lambertian light 110 exits display system 400 having a peak intensity Ip at a first exit angle α1 and a peak intensity of about Ip/2 at a second exit angle α2. In some embodiments, a magnitude of a difference between the first exit angle α1 and the second exit angle α2 may be less than about 20 degrees, or less than about 15 degrees, or less than about 10 degrees, or less than about 5 degrees.

In some embodiments, first exit angle α1 may be less than about 10 degrees, or less than about 8 degrees, or less than about 6 degrees, or less than about 4 degrees, or less than about 2 degrees, or less than about 1 degree (e.g., about 0 degrees). In some embodiments, first exit angle α1 may be greater than about 5 degrees, or greater than about 10 degrees, or greater than about 15 degrees, or greater than about 20 degrees (e.g., about 20 degrees, plus or minus).

In some embodiments, second exit angle α2 may be greater than about 10 degrees, or greater than about 12.5 degrees, or greater than about 15 degrees, or greater than about 17.5 degrees, or greater than about 20 degrees, or greater than about 25 degrees, or greater than about 30 degrees.

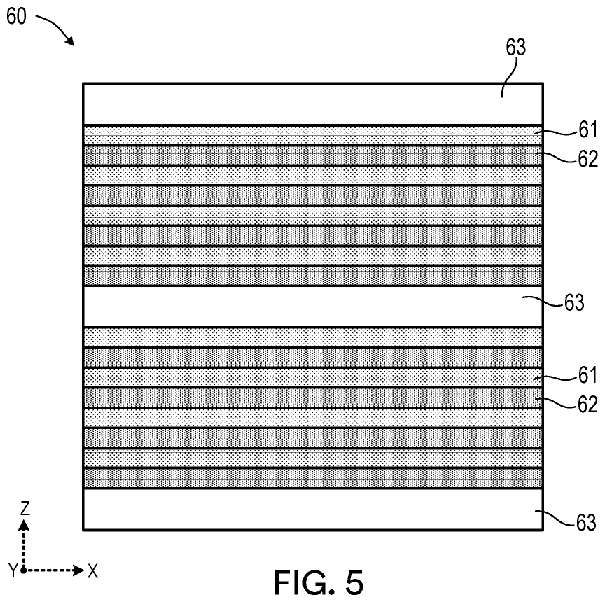

FIG. 5 is a schematic, side view of a multilayer optical film, such as substrate layer 60 of FIG. 1. As discussed elsewhere herein, in some embodiments, a substrate layer 60 may be disposed on the light rejecting second layer 40 opposite the first layer 31. In some such embodiments, the substrate layer may have a multilayer structure and include a plurality of polymeric layers 61, 62 as shown in FIG. 5, the polymeric layers numbering at least 10, or at least 20, or at least 50, or at least 100, or at least 200, or at least 300, or at least 400 in total. In some embodiments, an average thickness of each of the polymeric layers may be less than about 500 nm, or less than about 450 nm, or less than about 400 nm, or less than about 350 nm, or less than about 300 nm, or less than about 250 nm, or less than about 200 nm. In some embodiments, substrate layer 60 may further include at least one skin layer 63 having an average thickness of greater than about 500 nm, or greater than about 750 nm, or greater than about 1000 nm, or greater than about 1250 nm, or greater than about 1500 nm.

In some embodiments, the indices of refraction of alternating polymeric layers 61, 62 may have different indices of refraction from each other. In some embodiments, the indices of refraction of at least one of the alternating polymeric layers 61, 62 may vary across a profile of layers in the z-direction, as shown by the coordinate system in FIG. 5. In some embodiments, a profile plotting various physical and optical characteristics of alternating polymeric layers 61, 62 such as index of refraction, thickness, etc. may vary (e.g., may show a changing gradient of one or more of the characteristics, may vary randomly, continuously, non-continuously, etc.). In this way, optical transmission characteristics of the substrate layer may be modified to meet a specific requirement. For example, in some embodiments, for a substantially normally incident light and a visible wavelength range extending from about 420 nm to about 680 nm, the plurality of polymeric layers 61, 62 may have an average reflectance of greater than about 50%, or greater than about 60%, or greater than about 70%, or greater than about 80%, or greater than about 90%, or greater than about 95% when the incident light is polarized along a first in-plane direction (e.g., along the x-axis) and an average transmittance of greater than about 60%, or greater than about 70%, or greater than about 80%, or greater than about 90%, or greater than about 95% when the incident light is polarized along an orthogonal second in-plane direction (x-axis).

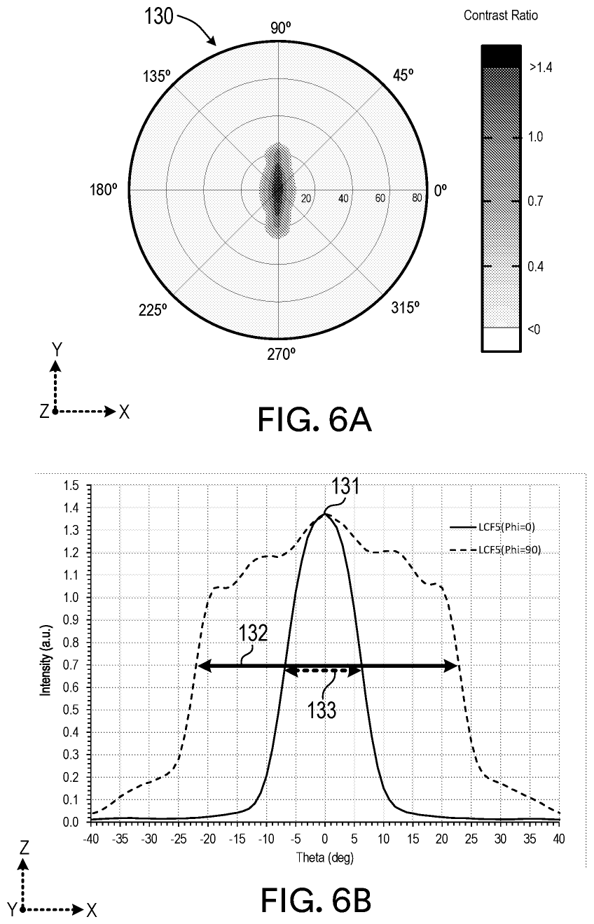

Finally, FIGS. 6A-6B provide plots showing the optical characteristics of an embodiment of an angular light control film, according to the present description. FIG. 6A represents an example conoscope plot showing an intensity profile for light exiting from a light control film (after passing through the first beads 30, FIG. 1, and light control film 20 in FIGS. 1 and 4A) when the light rejecting layer side of the light control film 20 is illuminated with a substantially Lambertian light source (e.g., see element 100, FIG. 4B) that emits a Lambertian light (e.g., light 110, FIG. 4B) that has a substantially Lambertian intensity distribution across the light rejecting layer. In some embodiments, the profile of the exiting light may have intensity profile 130 which has a peak 131 (see FIG. 6B) along a peak direction (e.g., the z-axis shown in FIG. 6A) making a peak angle with a normal to the light rejecting layer and a corresponding largest full width at half maximum, FWHM 132 in a first plane (e.g., the yz-plane as indicated in FIG. 6B, showing a plot of intensity vs. degrees) that comprises the peak direction, and a second FWHM 133 in a second plane (e.g., the xz-plane) that includes the peak direction and is orthogonal to the first plane. In some embodiments, a ratio of the largest FWHM to the second FWHM is at least 1.1, or at least 1.2, or at least 1.3, or at least 1.4, or at least 1.5, or at least 2, or at least 2.5, or at least 3.

In some embodiments, the peak angle may be less than about 10 degrees, or less than about 8 degrees, or less than about 6 degrees, or less than about 4 degrees, or less than about 2 degrees. For example, the peak angle shown in the plot of FIG. 6B is about 0 degrees. In some embodiments, the largest FWHM may be less than about 60 degrees, or less than about 50 degrees, or less than about 40 degrees, or less than about 30 degrees, or less than about 20 degrees. In some embodiments, the second (smaller) FWHM may be less than about 30 degrees, or less than about 25 degrees, or less than about 20 degrees, or less than about 15 degrees, or less than about 10 degrees.

### EXAMPLES

All parts, percentages, ratios, etc. in the Examples and the rest of the specification are by weight, unless noted otherwise.

TABLE 1
Materials Used in the Examples

| Abbreviation or | |
|---|---|
| Trade Designation | Description |
| SR399 LV | Low viscosity dipentaerythritol pentaacrylate obtained under the trade |
| | designation “SR399 LV” from Sartomer Americas, Exton, PA |
| SR833S | Difunctional tricyclodecanedimethanol diacrylate obtained under the |
| | trade designation “SR833S” from Sartomer Americas, Exton, PA |
| CN147 | Acidic acrylate oligomer obtained under the trade designation “CN147” |
| | from Sartomer Americas, Exton, PA |
| Klun90 | See preparative example 7 of U.S. Pat. No. 9,790,396. |
| IR 184 | A photoinitiator obtained under the trade designation “IGACURE 184” |
| | from BASF Corporation, Tarrytown, NY |
| Esacure One | Difunctional oligomeric alpha hydroxy ketone photoinitiator obtained |
| | under the trade designation “ESACURE ONE” from IGM Resins USA, |
| | Charlotte, NC |
| IPA | Isopropyl alcohol obtained from Aldrich Chemical |
| 1-methoxy-2-propanol | Dow Chemical Company, Midland MI |
| TEGORAD 2250 | Silicone polyether acrylate obtained under the trade designation |
| | “TEGORAD 2250” from Evonik Goldschmidt Corp., Hopewell, VA |
| SSX-108 | Crosslinked polymethmethacrylate spherical particle obtained under trade |
| | designation “SSX-108” from Sekisui Kasei Co., Ltd. |
| Carbon black | Carbon black pigment from Cabot Corporation, Boston, MA |
| IBOA | Isoborneol Acrylate obtained from Sigman-Aldrich, St. Louis, MO |

### GENERAL DESCRIPTION

The order of operations to prepare these examples begins with coating of the desired light blocking layer onto the substrate, followed by coating of the spacer layer, followed by coating of the beaded microlens array layer.

### Preparation of Light Blocking Layers

Light blocking layers were made on polyethylene terephthalate (PET) substrates by vacuum deposition of a thin aluminum layer on the surface the PET. Optical density of the PET substrates with light blocking layer were measured with a Gretag-Macbeth AG D200-II with light source incident on the substrate. Our examples include light blocking layers with optical density 3.0. An organic polymer planarization layers is coated before the aluminum layer on the PET substrate, at a thickness of 100-1000 nm. In this example, we used SR833s from Sartomer deposited by evaporation and cured by electron beam radiation. A protective layer is coated on top of the light blocking layer by reactively sputtering silicon aluminum oxide at a thickness of about 10 nm. Optionally, an interlayer adhesion layer (or tie layer) is deposited before the light blocking layer is deposited to improve adhesion to underlying layers. The tie layer can be a layer of metal like titanium or nickel-chromium or other metals known to those skilled in the art. The thickness of this layer depends on the desired adhesion level and optical properties at the interface but can be as little as 1 nm or as much as 20 nm.

### Preparation of Coating Solutions for Spacer Layers

Spacer layer was prepared using SR833S monomer/CN147 oligomer/Klun90 in a ratio of 29.3:3:1, Irgacure 184 at 0.99 wt % solids in solvents 1-methoxy-2-propanol/IPA in ratio of 5.66:1. The wt % solids for spacer is 30%.

### Preparation of Coating Solutions for Beaded Microlens Array Layer

The beaded microlens coating solution is shown in table 2. The monomers, solvents (1-methoxy-2-propanol/IPA at 5.67:1 solvent ratio), ESACURE ONE photoinitiator (1.0 wt % solids) and TEGORAD 2250 surfactant were mixed together to form a homogenous solution.

Optically transparent beads SSX-108 with bead diameter of 8 μm were then added to the solution and further mixed to again form a homogenous solution with the optically transparent beads. The bead to monomer ratio in this solutions was 2.57:1 weight ratio.

The carbon black based light absorbing monomer mixture was made in the following manner. The carbon black based light absorbing monomer mixture was a carbon black-IBOA slurry which was made through a media milling process. A dispersant and IBOA were first mixed using a Dispermat CN-10 laboratory high-shear disperser (BYK-Gardner USA, Columbia MD) until fully dissolved, and then carbon black powder was slowly added under mixing. The slurry was composed of 30% wt carbon black, 55% IBOA, and 15% dispersant. The fully mixed slurry was milled using a LabStar laboratory media mill (Netzsch, Exton PA) with 0.5 mm yttria stabilized zirconia milling media. Small amounts of samples were taken out periodically to monitor the milling progress. The fineness of grind of the final slurry was 7.5-8 Hegman unit (or less than 6.5 microns) measured by a Grindometer 100 (BYK Instrument, Columbia MD) as disclosed in ASTM D1210.

For the purpose of quantifying the optical density of resin systems for bead-free finished coating regions, we made a range of calibration samples of differing thickness using a bead coating solution A but without the addition of beads.

TABLE 2
Beaded coating solution

| Bead Coating | | Monomer | | | |
|---|---|---|---|---|---|
| Solutions | Monomers | Ratio | Surfactant | Bead | % Solids |
| A | SR399LV/carbon | 1:0.33 | Tegorad 2250 | SSX-108 | 40 |
| | black based | | (0.12 wt % | | |
| | monomer mixture | | solution) | | |

### General Coating Process

A range of bead-free coatings were coated dried and cured on a clear PET substrate at several thicknesses to measure optical density versus thickness. Optical density was measured with a Gretag-Macbeth AG D200-II on the dry/cured coating on PET with the light incident from the PET side. The coating process was as follows: Solution was supplied at a range of specified rates (cc/min) as specified in the table below to a 4 inch (10.2 cm) wide slot type coating die and coated on PET. After the solution was coated on the substrate, the coated web travelled a 10 ft (3m) span in the room environment, and passed through two 5 ft (1.5m) long zones of small gap drying with plate temperatures set at 190 °F (88 C). The substrate was moving at a speed 10 ft/min (304.8 cm/min) specified in the table below to achieve the wet coating thickness specified in Table 3 below. Finally, the dried coating entered a UV chamber equipped with a Fusion System Model I300P where an H-bulb was used. The UV chamber was purged by nitrogen at a flow rate of 11 scfm (310 liters/min) which resulted in an oxygen concentration of approximately 50 ppm.

TABLE 3
Light absorbing monomer mixture optical density -
coating process for calibration solution

| Coating | Coating | | Calculated | |
|---|---|---|---|---|
| Flow | Web | Coating | Wet Coating | Dry Coating |
| Rate | Speed | Width | Thickness | thickness |
| (cc/min) | (cm/min) | (cm) | (micron) | (micron) |
| 1.31 to 5.24 | 304.8 | 10.16 | 4.23 to 16.92 | 0.5 to 2.0 |

The measured optical density of the coated dried and cured light absorbing monomer mixture versus dried and cured coating thicknesses between 0.5 microns and 2 microns thick resulted in a linear fit with OD=0.797×Thickness [microns]+0.02.

### Spacer Layer Coating:

Clear spacer layer coatings were coated, dried, cured on the aluminum deposited surface of light blocking substrate described above. The spacer layer coatings were made to target of 2.7 micron thickness after coating, drying, and curing. The coating solution was supplied to an 8 inch (20.3 cm) wide slot type coating die, onto a 0.00114 inch (29 micron) thick Al metalized PET film web moving at a speed of 60 ft/min (18.3 m/min). The metalized film had an OD 3. The rate of application of the coating solution was 38.7 g/min. After coating, the web travelled approximately 13 ft (3.9 m) before entering a 30 ft (9.1 m) conventional air floatation drier with three 10 ft (3 m) zones set at 38, 49, and 71 °C, respectively. After drying and before winding, the coating was transported through a UV curing systems (Model VPS/1600 from Fusion Systems Inc., Gaithersburg, MD). The Fusion system was configured with an H-bulb and was operated 100% power. The UV chamber was purged by nitrogen at a flow rate of 16 scfm (450 liters/min) resulting in less than 50 ppm oxygen in the cure zone.

### Beaded Microlens Array Layer Coating Process

Beaded microlens solution was coated, dried and cured on the Spacer Layer coating. The solution was supplied to an 8 inch (20.3 cm) wide slot type coating die, onto the surface of solidified first coating at a speed of 40 ft/min (12.2 m/min). The rate of application of the coating solution was 44.1 cm³/min. After coating, the web travelled approximately 13 ft (3.9 m) before entering a 30 ft (9.1 m) conventional air floatation drier with three 10 ft (3 m) zones set at 104, 60, and 71 °C, respectively. After drying and before winding, the coating was transported through a UV curing systems (Model VPS/1600 from Fusion Systems Inc., Gaithersburg, MD). The Fusion system was configured with an H-bulb and was operated 100% power at less than 50 ppm oxygen in the cure zone.

The coating, drying, curing of the beaded microlens solutions generated closely packed monolayer bead coatings on the substrates with near full hemisphere bead protrusions. Given approximately half of the top portions of the monolayer beads are protruding, it can be estimated that the bottom half of the beads are embedded in the cured monomer layer component with the bottom most tip of the beads in near contact with the substrate. An estimate of the optical density through the non-bead areas in the monolayer coating itself in the direction perpendicular to the plane of the substrate can then be calculated for monolayer bead coatings with light absorbing monomer mixtures using the optical density vs. caliper relationship, where film OD=0.797×Thickness [microns]+0.02.

### Laser Processing

Laser processing was subsequently performed to create an array of openings in the thin aluminum light blocking layer using a laser system comparable to the system described in PCT Publication No. WO 2020/035768 to Biyiki et al. and entitled OPTICAL ELEMENT INCLUDING MICROLENS ARRAY. This process included using a pulsed 1064 fiber laser (Trumpf TruNano) coupled to a polygon scanner (NextScan Technology). A linear stage (Aerotech) was used to feed the samples through the scanning laser. The laser pulse rate was set between 1 and 2 MHz with a spot size of approximately 450 micron. The pulse width was set between 10 and 30 ns and the laser power was set between 100 and 200 W. The feed rate of the linear stage was set to about 20 mm/s.

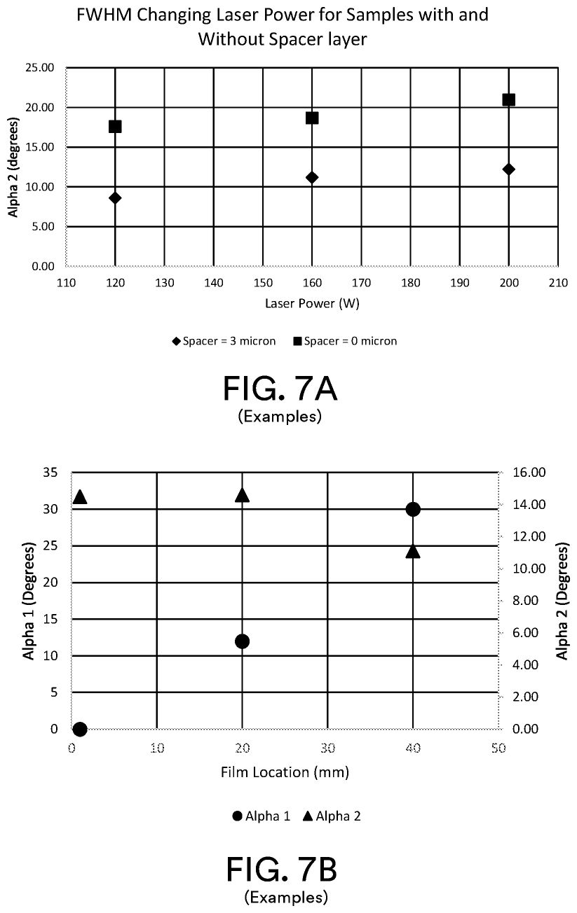

FIG. 7A illustrates demonstrated samples using different laser powers and spacer layer thicknesses. The powers used were 120 W, 160 W, and 200 W and the two spacer layer thicknesses were 0 microns and 3 microns, optimized for the 8-micron bead focal length. Samples 2 and 3 in Table 4 are drawn from this figure to provide more information on the processing and performance of the samples.

FIG. 7B illustrates the range of α1 demonstrated, 0 to 30 degrees. These samples were processed on the Main Line and laser processed with 160 W. A 100 mm focal length lens was used to change the incident laser angle. Sample 4 in Table 4 includes more information on the processing and operation of the maximum angular output.

To selectively increase the field of view in one direction as shown in FIG. 6B, in-house made microreplicated turning films with 5 degrees and 19 degrees output were used to change the laser incident angle on the sample. The sample underwent 5 sequential laser processing steps. The sample was processed at normal incidence, 0 degrees, followed by two passes at 5 degrees and 2 passes at 19 degrees, turning the sample 180 degrees between processing steps.

### Optical Characterization

Optical characterization was carried out using an Eldim conometer. The samples were illuminated using a backlit PTFE slab that acts as a sufficiently Lambertian light source.

TABLE 4
Summary angular transmission data and descriptions of Examples

| | | Bead | Spacer | Laser | | |
|---|---|---|---|---|---|---|
| | | Diameter | Thickness | Power | α1 | α2 |
| Example | Description | (micron) | (micron) | (W) | (degrees) | (degrees) |
| 1 | Instantiation | 5 | 3 | 160 | 0 | 16 |
| | with Different | | | | | |
| | Size Beads | | | | | |
| | α1 = 0 degrees | | | | | |
| 2 | Instantiation | 8 | 0 | 200 | 0 | 21 |
| | with no Spacer | | | | | |
| | Layer, | | | | | |
| | α1 = 0 degrees | | | | | |
| 3 | Instantiation | 8 | 3 | 120 | 0 | 8.6 |
| | with Spacer | | | | | |
| | Layer equal to | | | | | |
| | Focal Length | | | | | |
| | α1 = 0 degrees | | | | | |
| 4 | Instantiation | 8 | 3 | 160 | 30 | 11 |
| | with 30 degree | | | | | |
| | off-normal | | | | | |
| | Incidence | | | | | |
| | α1 = 30 | | | | | |
| | degrees | | | | | |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical assembly comprising:
an extended illumination source configured to emit light from an extended emission surface thereof; and
a light control film disposed on, and substantially co-extensive in length and width with, the extended illumination source and comprising:
a plurality of optically transparent first beads at least partially embedded in a first layer; and
a light rejecting second layer disposed between, and substantially parallel to, the first layer and the emission surface, the light rejecting second layer defining a plurality of through openings therein extending between opposite major top and bottom surfaces of the light rejecting second layer, the through openings aligned to the first beads in a one-to-one correspondence.

2. The optical assembly of claim 1, wherein the first beads are completely embedded in the first layer.

3. The optical assembly of claim 2, wherein at least some of the completely embedded first beads define corresponding protrusions on a major top surface of the first layer.

4. The optical assembly of claim 1, wherein a spacer layer is disposed between the first layer and the light rejecting second layer.

5. The optical assembly of claim 4, wherein a thickness of the spacer layer is such that when a substantially collimated light is substantially normally incident on the optical assembly, then each of the first beads focuses the incident light to a focal spot disposed within, or adjacent to, the through opening corresponding to the first bead.

6. The optical assembly of claim 1 further comprising a substrate layer disposed on the light rejecting second layer opposite the first layer.

7. The optical assembly of claim 6, wherein the substrate layer comprises a plurality of polymeric layers numbering at least 10 in total, wherein an average thickness of each of the polymeric layers is less than about 500 nm.

8. (canceled)

9. The optical assembly of claim 7, wherein for a substantially normally incident light and a visible wavelength range extending from about 420 nm to about 680 nm, the plurality of polymeric layers has an average reflectance of greater than about 50% when the incident light is polarized along a first in-plane direction and an average transmittance of greater than about 60% when the incident light is polarized along an orthogonal second in-plane direction.

10. (canceled)

11. The optical assembly of claim 1, wherein the light rejecting second layer rejects light primarily by absorbing the light, the optically absorbing light rejecting second layer having an average optical density of greater than about 1 in a visible wavelength range extending from about 420 nm to about 680 nm.

12. The optical assembly of claim 11, wherein the optically absorbing light rejecting second layer comprises one or more of a light absorbing pigment, a light absorbing dye and carbon black.

13. The optical assembly of claim 11, wherein the optically absorbing light rejecting second layer has a black or a dark gray color.

14. The optical assembly of claim 1, wherein the light rejecting second layer rejects light primarily by reflecting the light, the optically reflective light rejecting second layer having an average optical reflectance of greater than about 50% in a visible wavelength range extending from about 420 nm to about 680 nm.

15. The optical assembly of claim 14, wherein the optically reflective light rejecting second layer comprises a metal.

16. The optical assembly of claim 15, wherein the metal comprises one or more of silver, copper, gold, aluminum, and tungsten.

17. The optical assembly of claim 1, wherein the first layer is optically transparent having an average optical transmittance of greater than about 80% in a visible wavelength range extending from about 420 nm to about 680 nm.

18. The optical assembly of claim 1, wherein the first layer is optically light absorbing having an average optical density of greater than about 0.05 in a visible wavelength range extending from about 420 nm to about 680 nm.

19. (canceled)

20. The optical assembly of claim 1, wherein the extended illumination source comprises:
a reflective layer;
an optically diffusive layer disposed on the reflective layer and comprising, or disposed proximate, the extended emission surface, the optically diffusive layer and the reflective layer substantially coextensive with each other in length and width and defining an optical cavity therebetween; and
at least one light source disposed in or proximate the optical cavity.

21. The optical assembly of claim 1, wherein the extended illumination source comprises a reflective polarizer, such that for a substantially normally incident light and a visible wavelength range extending from about 420 nm to about 680 nm, the reflective polarizer has an average reflectance of greater than about 60% when the incident light is polarized along a first in-plane direction and an average transmittance of greater than about 60% when the incident light is polarized along an orthogonal second in-plane direction.

22. The optical assembly of claim 1, wherein the extended illumination source comprises a first prismatic film comprising a plurality of first prisms extending along a first longitudinal direction.

23. The optical assembly of claim 18, wherein the extended illumination source further comprises a second prismatic film disposed proximate the first prismatic film and comprising a plurality of second prisms extending along a second longitudinal direction different from the first longitudinal direction.

24.-43. (canceled)
